(19) United States
(12) Patent Application Publication
(10) Pub. No.: US 2025/0161913 A1
(43) Pub. Date: May 22, 2025

(54) USE OF AN ADSORBENT AND METERING UNIT COMPOSED OF ADSORBENT FOR THIS USE

(71) Applicant: Mecana AG, Reichenburg (CH)

(72) Inventors: Ulrich GRABBE, Buttikon (CH); Thomas FUNDNEIDER, Reichenburg (CH)

(73) Assignee: Mecana AG, Reichenburg (CH)

(21) Appl. No.: 18/841,447

(22) PCT Filed: May 8, 2023
(86) PCT No.: PCT/EP2023/062109

§ 371 Date: Aug. 26, 2024

(30) Foreign Application Priority Data
May 16, 2022 (DE) 10 2022 112 174.7

(51) Int. Cl. B01J 20/28; B01J 20/12; B01J 20/20; B01J 20/30; C02F 1/28; C02F 101/10; C02F 101/30

(52) U.S. Cl. CPC B01J 20/28021; B01J 20/12; B01J 20/20; B01J 20/28004; B01J 20/3028; B01J 20/3035; C02F 1/281; C02F 1/283; C02F 2101/105; C02F 2101/30

(57) ABSTRACT

An adsorbent and a metering unit are used in a facility for processing liquids for removing dissolved organic and/or inorganic substances. The water-soluble metering unit, which contains an adsorbent, is metered into the liquid to be treated, in order to remove dissolved organic and/or inorganic substances depending on the amount of dissolved organic and/or inorganic substances to be removed, wherein the adsorbent is released. When metered into the liquid to be treated, the metering unit disintegrates or disperses and releases the adsorbent which, on account of the then extremely large surface area, can bind high quantities of dissolved organic/inorganic substances.

### CROSS REFERENCE TO RELATED APPLICATIONS

This application is the National Stage of PCT/EP2023/062109 filed on May 8, 2023, which claims priority under 35 U.S.C. § 119 of German Application No. 10 2022 112 174.7 filed on May 16, 2022, the disclosure of which is incorporated by reference. The international application under PCT article 21(2) was not published in English.

### BACKGROUND OF THE INVENTION

### 1. Field of the Invention

The invention relates to the use of an adsorbent in a facility for processing liquids for removing dissolved organic and/or inorganic substances. It also relates to a metering unit of adsorbent for this use.

It relates in particular to the use of an adsorbent in a facility for processing liquids (such as municipal wastewater or industrial wastewater, drinking water, groundwater, lake/sea and river water, rainwater, mixed water and surface runoff), with the aim of removing dissolved organic substances, such as dissolved organic carbon (DOC) or trace substances or microimpurities (for example pharmaceuticals, industrial and household chemicals), and/or inorganic substances such as phosphates, ammonium compounds or metals.

### 2. Description of the Related Art

DE 10 2013 006 985 A1 describes a method for removing dissolved substances in water, from water, which is drinking water, surface water, process water or wastewater, by means of powder adsorbents, which method is used in the process preparation in the chemical industry and in water and wastewater technology, preferably in drinking water treatment and wastewater treatment, and a device for carrying out the method. For adsorption of dissolved substances in water, an adsorbent, in particular powdered activated carbon, is used.

EP 0 530 396 A1 discloses a method for precipitation of phosphates out of phosphate-containing water, using an iron hydroxide.

EP 3 957 608 A1 describes a method and a device for treating wastewater, in particular for eliminating microimpurities in a purification plant comprising a reactor that has an inlet opening for the wastewater, a contact zone in which granulated activated carbon interacts with the wastewater, a supernatant zone, and a subsequent outlet opening from which the purified wastewater exits.

A method for removing impurities from water, in particular groundwater and drinking water, is known from WO 2020/118513 A1, which method comprises the following steps:
adding powdered activated carbon in the submicron range (sPAC) to an inflow of water to be treated;
mixing the sPAC with the water to be treated;
introducing a mixture of sPAC and water into a sorption reactor for treatment;
leaving the mixture in the sorption reactor for a sufficient dwell time in order that the sPAC can adsorb impurities in the water; and.
transferring the mixture from the sorption reactor, using a return pump, to a high-speed ceramic membrane filter unit which operates in cross-flow filtration, wherein the treated water is discharged as a permeate and the sPAC is returned to the sorption reactor as the retentate.

EP 2 536 497 A1 relates to an adsorptive system, in particular based on an agglomerate, comprising a plurality of adsorber particles, wherein the adsorber particles are fixed to a binder carrier, in particular caused to adhere, and are connected via the binder carrier to the adsorptive system, in particular to an adsorbent, and wherein the adsorber particles comprise a first particulate adsorption material and a second particulate adsorption material that is different from the first particulate adsorption material. An adsorptive system of this kind is used in the field of filter technology.

EP 2 440 496 B1 discloses a device for treating an aqueous liquid by contacting with a fluidized bed of coagulated carbon in powder form.

EP 3 009 405 A1 describes a method for treating water in order to reduce the content of organic substances and harmful substances, wherein the method comprises the following:
a first step of bringing the water to be treated into contact with a granular adsorption material, which is performed such that a contact time of the water with a granular adsorption material of 5 to 20 minutes is complied with,.
followed by a second step of purifying the mixture of water and adsorption material from the first step, which leads in the one hand to obtaining purified water, and on the other hand to obtaining used granular adsorption material.

In this case, the adsorption material consists of agglomerates of activated carbon particles, wherein the agglomerates have an average size of between 20 μm and 1000 μm and an iodine value of more than 1000 mg/g.

EP 3 231 771 A1 discloses a method for treating water for the purpose of reducing the content of organic materials and harmful substances therein, wherein the method comprises a step of bringing into contact water to be treated with an adsorbing granulate material in a contact container provided with stirrers; followed by a step of purifying the water emerging from the container, which leads to obtaining purified water and slurry, wherein the adsorbing granulate material consists of agglomerates of activated carbon particles, wherein the agglomerates have an average size of between 200 μm and 600 μm, and a specific surface area of between 800 and 1000 m²/g.

Adsorptive structures based on agglomerates, which each comprise a plurality of grain-shaped, preferably spherical, adsorber particles, and the production of these agglomerates, and their use, are described in EP 2 349 556 B1. In this case, the adsorber particles of the individual agglomerates are in each case interconnected via a preferably thermoplastic organic polymer, in particular binder, or the adsorber particles of the individual agglomerates are bound to and/or caused to adhere to a preferably thermoplastic organic polymer, in particular binder. The adsorptive structures are used for adsorption of toxic substances, harmful substances and odors, in particular from gas or air streams or from liquids, in particular water.

EP 0 209 790 A2 describes a method for producing filler-containing, polymer-bound carrier masses, the carrier masses obtained according to this method, and the use thereof.

WO 2021/078956 A1 discloses a method for purifying dirty water, wherein an adsorbent is metered into the dirty water, in a purification tank, which adsorbent comprises powdered activated carbon.

US 2017/0297040 A1 describes a method for treating water, wherein a granular adsorbent in the form of activated carbon particles is used.

### SUMMARY OF THE INVENTION

The object of the invention consists in providing an improved method for removing dissolved organic and/or inorganic substances in liquids using an adsorbent.

This object is achieved according to the invention in that a water-soluble metering unit, which contains an adsorbent, selected from the group consisting of activated carbon, bentonite, zeolite, polymer adsorbents, iron oxide, iron hydroxide, silica gel or mixtures thereof, and additives, selected from the group consisting of divalent or trivalent iron and aluminum salts, iron oxide, iron hydroxide, polymers and binders and disintegrants, is metered into the liquid to be treated, in order to remove dissolved organic and/or inorganic substances depending on the amount of dissolved organic and/or inorganic substances to be removed, wherein, when metered into the liquid to be treated, the metering unit disintegrates or disperses and releases the adsorbent, wherein the adsorbent consists of particles of powdered adsorbent having a particle diameter d₅₀ of 0.1 to 500 μm, preferably of 1 to 100 μm.

In the form of metering units, the adsorbent is not associated with any risk of explosion. Thus, the adsorbent can be stored and handled without problem. When metered into the liquid to be treated, the metering unit disintegrates or disperses and releases the adsorbent which, on account of the then extremely large surface area, can bind high quantities of dissolved organic/inorganic substances.

A preferred, but not exclusive, field of use of the adsorbent is wastewater treatment, in particular in chemical/biological systems (such as membrane biosystems, SBR systems, single-stage or two-stage activated sludge processes, processes using aerobic and/or anaerobic granular matter) and/or following chemical/biological systems, such as in what is known as the fourth purification stage.

In principle, any adsorbent is suitable which can adsorb the dissolved, preferably organic/inorganic, substances. These may for example be anthropogenic organic trace substances (such as active pharmaceutical ingredients, X-ray contrast media, substances from body care and cleaning products, biocides, flame retardants, perfluorinated chemicals), and/or organic carbon compounds, and/or inorganic substances such as phosphates, ammonium compounds or metals. The adsorbent can be composed of activated carbon, bentonite, zeolite, polymer adsorbents, iron oxide, iron hydroxide (such as β-FeOOH (akageneite)) or silica gel, and mixtures thereof. The raw material of the adsorbent is present in powder and/or suspended form (for example in the case of activated carbon: powdered activated carbon (PAC) and/or superfine powdered activated carbon (sPAC) and consists of substances which are matched to the dissolved organic and/or inorganic substances or the liquid matrix.

The metering unit can be present in the form of a pill created by pressing/freeze-drying/3D printing/casting/extruding the powdered/suspended adsorbent. A pill of this kind can be prepared from powdered adsorbent alone, for example by applying pressure/freeze-drying, and/or by adding binders and/or disintegrants, wherein the binder and/or disintegrant must be selected such that the adsorbent is released upon contact with liquid.

It is also possible for the metering unit to be present in the form of a capsule, in which a hard or soft water-soluble sheath encloses the powdered adsorbent.

Likewise, the metering unit can be present in the form of a pod, wherein a hard or soft water-soluble sheath encloses the suspended adsorbent.

In this connection it is also possible for the adsorbent to be present in foamed form.

The form, size and composition of the metering unit and a possible sheath thereof is matched such that the reaction of the adsorbent with the substances to be removed, in the liquid matrix, proceeds optimally in accordance with the respective process. The input of the metering units can for example take place in the process chain at locations of high turbulence or high energy input, which assists the release and uniform distribution of the adsorbent.

However, the timepoint of the release can also be purposely controlled by the structure of the metering unit, for example the selection of the sheath thereof, such that a continuous input of the adsorbent takes place. It must merely be ensured that the metering unit disintegrates in contact with the liquid or the organic/inorganic substances. In order to assist the release of the adsorbent, process-related units (such as agitators or macerators) can be purposely implemented or used. Furthermore, a pre-release outside of the liquid to be treated and subsequently purposeful input into the process stream using a separate unit is possible.

The additives serve in particular for agglomeration of the adsorbent, and for assisting the release of the adsorbent after contacting the metering unit with the liquid, and for separating the adsorbent in separation processes such as sedimentation and/or floatation and/or filtration, as well as precipitation of dissolved substances (such as phosphates, metals), and/or for assisting the above-mentioned deposition process.

It is advantageous for the polymers to be selected from cationic, anionic and non-ionic polymers.

It is advantageous for the binder (for cohesion of the adsorbent) or the disintegrant (for assisting the release of the adsorbent) to be selected from biodegradable substances (such as polyvinyl alcohol, polyvinyl pyrrolidone, gelatine, (microcrystalline) cellulose, carrageen, starch, starch ester, glucose, lactose, saccharose, maltodextrin, polyacrylic acid, colloids, albumen) or non-biodegradable substances (such as salts). It is advantageous for the binder or disintegrant to be selected from easily biodegradable compounds. The easily biodegradable compounds can then serve as nutrient sources for downstream processes for separation, where biological processes are intended to be assisted.

In the context of the invention, the additives can be present both in crystalline and in powder form.

In the case of additives in solid form, these can be present both in the form of an additive coating on the adsorbent or a sheath of the adsorbent that dissolves upon contact with liquid, or also distributed substantially homogeneously in the adsorbent.

Alternatively, the additives can also be present in liquid and/or suspended form.

The scope of the invention also covers a metering unit for use in the method according to the invention, which metering unit is water-soluble and comprises at least one adsorbent, selected from the group consisting of activated carbon, bentonite, zeolite, polymer adsorbents, silica gel, or mixtures thereof, and at least one additive, selected from the group consisting of divalent or trivalent iron and aluminum salts, iron oxide, iron hydroxide, polymers and binders or disintegrants, wherein the adsorbent forms a hollow sheath that encloses the additive.

Likewise, the scope of the invention also covers a metering unit for use in a method, which metering unit is water-soluble and comprises at least one adsorbent, selected from the group consisting of activated carbon, bentonite, zeolite, polymer adsorbents, silica gel, or mixtures thereof, and at least one additive, selected from the group consisting of divalent or trivalent iron and aluminum salts, iron oxide, iron hydroxide, polymers and binders or disintegrants, wherein the additive forms a hollow sheath that encloses the adsorbent.

In the case of liquid additives, a hollow metering unit can be formed from the adsorbent, which metering unit encloses the liquid additives. Upon release of the adsorbent, the liquid additives contained therein are then also released.

Vice versa, it is also possible for the adsorbent to be present in liquid or foamed form and to be enclosed by a sheath of solid additives, in order to form the metering unit.

The invention also relates to a metering unit for the use according to the invention, wherein the metering unit is water-soluble and comprises an adsorbent, selected from the group consisting of activated carbon, bentonite, zeolite, polymer adsorbents, silica gel, or mixtures thereof, and additives, selected from the group consisting of metal salts, iron oxide, iron hydroxide, polymers and binders or disintegrants.

It is within the scope of the invention for the additives to be present in powdered form and preferably in the form of an additive coating on the adsorbent, or a sheath of the adsorbent that dissolves upon contact with liquid, or distributed substantially homogeneously in the adsorbent.

Alternatively, it is also advantageous for the additives to be present in liquid form and preferably for a hollow adsorbent to be present, which encloses the liquid additives.

Examples for embodiments of the metering units will be explained in greater detail in the following.
1. Metering unit in the form of a pill:
   Adsorbent: PAK having a grinding fineness of 80%<40 μm; 500 mg activated carbon/pill
   Additives: Polyvinyl pyrrolidone, alginate.
   Preparation of the pill by pressing the powdered adsorbent, mixed with the additives, under high pressure
2. Metering unit in the form of a capsule:
   Adsorbent:
      PAK having a grinding fineness of 80%<40 μm; 100 mg/capsule
      Bentonite having a grinding fineness of 80%<40 μm; 100 mg/capsule
   Additives: Gelatine
   Preparation: The additives are present in the form of a capsule which encloses the powdered adsorbent
3. Metering unit consisting of an adsorbent covered with a water-soluble additive:
   Adsorbent:
      sPAC having a grinding fineness of 80%<5 μm; 200 mg/capsule
      Bentonite having a grinding fineness of 80%<40 μm; 50 mg/capsule
   Additives: Polyvinyl alcohol; iron (II) chloride, starch
   Preparation: Pressing the powdered adsorbent under high pressure, applying a coating consisting of the additives to the pressed adsorbent

### BRIEF DESCRIPTION OF THE DRAWINGS

FIGS. 1 to 5 show embodiments of the metering unit according to the invention.

In the figures:

FIG. 1 shows a metering unit in the form of a pill,

FIG. 2 shows a metering unit in the form of a capsule,

FIG. 3 shows a metering unit in the form of an adsorbent/additive compound having a water-soluble sheath,

FIG. 4 shows a metering unit in the form of an additive casing which is filled with a liquid adsorbent,

FIG. 5 shows a foamed adsorbent/additive compound.

### DETAILED DESCRIPTION OF PREFERRED EMBODIMENTS

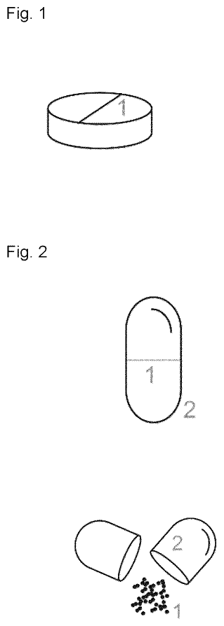

As can be seen from FIG. 1, the metering unit can be present in the form of a pill which is prepared by pressing the adsorbent 1, optionally with the addition of binders and optionally further additives.

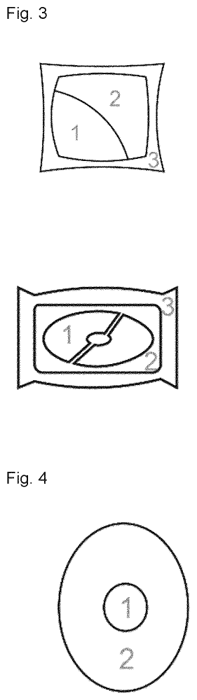

FIG. 2 shows a metering unit in the form of a capsule. This can be both a hard capsule and a soft capsule. In the present case, a powdered adsorbent 1 is present in a capsule consisting of water-soluble additive 2 or water-soluble additives 2. Upon contact with water, the capsule dissolves and the adsorbent 1 and the additive 2 or the additives 2 are released.

FIG. 3 shows a metering unit in the form of a compound consisting of the adsorbent 1 and a solid additive 2 or a plurality of solid additives 2, which compound is surrounded by a water-soluble sheath 3, as is known from dishwasher tabs. The sheath 3 can also consist of a further additive.

FIG. 4 shows a metering unit in the form of a liquid adsorbent 1 which is surrounded by a solid casing consisting of one or more additives 2. Vice versa, a liquid additive or a plurality of liquid additives could also be surrounded by a solid casing consisting of an adsorbent.

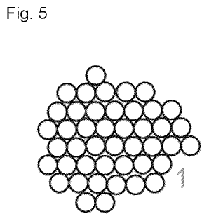

FIG. 5 shows that a foamed adsorbent/additive compound can also be present.

1-12. (canceled)

13. A method of using of an adsorbent in a facility for processing liquids for removing dissolved organic and/or inorganic substances, wherein a water-soluble metering unit, which contains an adsorbent, selected from the group consisting of activated carbon, bentonite, zeolite, polymer adsorbents, iron oxide, iron hydroxide, silica gel or mixtures thereof, and additives, selected from the group consisting of divalent or trivalent iron and aluminum salts, iron oxide, iron hydroxide, polymers and binders and disintegrants, is metered into the liquid to be treated, in order to remove dissolved organic and/or inorganic substances depending on the amount of dissolved organic and/or inorganic substances to be removed, wherein, when metered into the liquid to be treated, the metering unit disintegrates or disperses and releases the adsorbent, wherein the adsorbent comprisess particles of powdered adsorbent having a particle diameter d₅₀ of 0.1 to 500 μm, preferably of 1 to 100 μm.

14. The method according to claim 13, wherein the polymers are selected from cationic, anionic and non-ionic polymers.

15. The method according to claim 13, wherein the additives are present in solid form.

16. The method according to claim 15, wherein the additives are present in the form of an additive coating on the adsorbent or a sheath of the adsorbent that dissolves upon contact with liquid, or distributed substantially homogeneously in the adsorbent.

17. The method according to claim 13, wherein the additives are present in liquid form.

18. The method according to claim 17, wherein a hollow adsorbent is present, which encloses the liquid additives.

19. A metering unit for use in the method according to claim 13, wherein the metering unit is water-soluble and comprises at least one adsorbent (1), selected from the group consisting of activated carbon, bentonite, zeolite, polymer adsorbents, silica gel, or mixtures thereof, and at least one additive, selected from the group consisting of divalent or trivalent iron and aluminum salts, iron oxide, iron hydroxide, polymers and binders or disintegrants, wherein the adsorbent (1) forms a hollow sheath that encloses the additive (2).

20. A metering unit for use in the method according to claim 13, wherein the metering unit is water-soluble and comprises at least one adsorbent (1), selected from the group consisting of activated carbon, bentonite, zeolite, polymer adsorbents, silica gel, or mixtures thereof, and at least one additive, selected from the group consisting of divalent or trivalent iron and aluminum salts, iron oxide, iron hydroxide, polymers and binders or disintegrants, wherein the additive (2) forms a hollow sheath that encloses the adsorbent (1).
